(19) United States
(12) Patent Application Publication
(10) Pub. No.: US 2026/0331638 A1
(43) Pub. Date: Oct. 22, 2026

(54) THERMAL REGULATION DEVICE FOR A VEHICLE BATTERY PACK

(71) Applicant: VALEO SYSTEMES THERMIQUES, Le Mesnil-Saint-Denis (FR)

(72) Inventors: Julien Tissot, Le Mesnil-Saint-Denis (FR); Kamel Azzouz, Le Mesnil-Saint-Denis (FR); Moussa Nacer-Bey, Le Mesnil-Saint-Denis (FR); Julio Guerra, Le Mesnil-Saint-Denis (FR)

(73) Assignee: VALEO SYSTEMES THERMIQUES, Le Mesnil-Saint-Denis (FR)

(21) Appl. No.: 19/116,698

(22) PCT Filed: Sep. 21, 2023
(86) PCT No.: PCT/EP2023/076044

§ 371 Date: Mar. 28, 2025

(30) Foreign Application Priority Data
Sep. 29, 2022 (FR) 2209912

(51) Int. Cl. H01M 10/6566; H01M 10/613; H01M 10/615; H01M 10/625; H01M 10/6568; H01M 50/291; H01M 50/507

(52) U.S. Cl. CPC H01M 10/6566; H01M 10/613; H01M 10/615; H01M 10/625; H01M 10/6568; H01M 50/291; H01M 50/507

(57) ABSTRACT

A thermal regulation device for a battery includes a housing having at least two side walls and a circuit for circulation of the heat transfer fluid, and configured to house the battery including at least two battery cells. The heat transfer fluid circulates around the battery cells being supplied and discharged by input and output collectors. A spacer is installed between the battery cells, at least one of the collectors extends along the side wall. The circuit of the heat transfer fluid is defined at least in part by the spacer, and at least two orifices are arranged on the spacer. Each of the orifices open into the input collector and into the output collector, respectively.

### TECHNICAL FIELD

The invention relates to a thermal regulation device for a vehicle battery pack and to a cooling system comprising such a device.

The invention relates in particular to the technical field of the thermal regulation of batteries, and more particularly the cells constituting said battery, said cells being liable to release heat during their operation. The invention applies preferentially, but not exclusively, to the automotive field and more particularly to the field of electric powered and/or hybrid vehicles.

### PRIOR ART

A motor vehicle, and more particularly an electric and/or hybrid vehicle, requires one or more battery packs to produce the energy necessary for its operation. Each battery pack is composed of at least two cells, the electrical conduction of which is achieved by means of busbars (also called a “bar set” or “omnibus bar”). However, when the cells overheat, they may become swollen, thus risking being damaged. These swollen cells can also damage adjacent cells by coming into contact therewith.

Thus, in order to avoid the swelling of battery cells, two devices are provided. Firstly, a spacer is positioned between two adjacent cells, which allows said cells to be kept at a distance from one another. Secondly, a thermal regulation device is provided around the battery pack in order to control its temperature.

More particularly, in the field of motor vehicles, the thermal regulation device for a battery pack enables its cooling to be controlled. This device in fact makes it possible to modify the temperature of a battery pack, for example when starting the vehicle in cold weather, by increasing its temperature for example or, whether during driving or during a charging operation, by decreasing the temperature of the cells, which tend to warm up during use.

Such a thermal regulation device generally comprises a sealed enclosure in which the battery pack is positioned. A heat-transfer fluid is conducted via a circulation circuit passing around the battery cells, and allows the temperature of the battery pack to be controlled. Inlet and outlet collectors also allow the heat-transfer fluid to enter or exit the enclosure encasing the battery pack. However, such collectors often take up considerable space since they are generally positioned on a top wall of the enclosure, so as to open therein via openings provided for this purpose.

In the published patent document EP 2 608 309 A1, for example, the thermal regulation device of a battery pack comprises the circulation circuit for the heat-transfer fluid circulating between the battery cells, and inlet and outlet collectors of said fluid to/from said circuit. These collectors are positioned one below the other in the middle of two rows of battery cells forming said pack. However, the regulation device described in this document is complex, formed from numerous parts which may be difficult to install, as well as being bulky.

The invention aims to remedy the above-mentioned problems. More particularly, it is an object of the invention to reduce the size of the battery pack in height, by reducing the space taken up by the thermal regulation device.

The invention also has the object of maintaining a compression rate which is sufficient to avoid the swelling of the cells, and of maintaining a minimum distance between the cells so as to avoid damage to adjacent cells in the case of overheating. Thus the cells retain their electrical performance.

Finally, the invention allows the formation of an effective circulation circuit for the heat-transfer fluid within the spacer, by improving the coefficient of exchange and the homogeneity of cooling of the large side faces of the cells adjacent to said spacer.

### PRESENTATION OF THE INVENTION

The solution proposed by the invention is a thermal regulation device for a vehicle battery pack, said device comprising: a housing forming an enclosure sealed against a heat-transfer fluid, having at least two side walls and a top wall, and comprising a circulation circuit for the heat-transfer fluid, which housing is capable of housing the battery pack, which pack comprises at least two battery cells, the heat-transfer fluid circulating around the battery cells for thermal regulation thereof, inlet and outlet collectors respectively for supply and discharge of the heat-transfer fluid to/from said circulation circuit, a spacer being installed between the cells so as to space them apart from one another, at least one of the collectors extending along at least one side wall of the housing, the circulation circuit for the heat-transfer fluid is defined at least in part by the spacer, and at least two orifices are arranged on the spacer, each of the orifices opening respectively into the inlet collector and into the outlet collector.

The positioning of the collectors to the side of the housing of the battery pack allows a reduction in the size of said housing in the height direction. This reduction in size can facilitate its installation, in particular in a motor vehicle. Finally, integration of the circulation circuit in the spacer allows a reduction in the number of elements constituting the battery thermal regulation device, and hence a reduction in its size, while simplifying its design.

Further advantageous features of the apparatus that forms the subject matter of the invention are listed hereinbelow. Each of these features may be considered alone or in combination with the notable features defined hereinabove. Each of these features contributes, as appropriate, to solving specific technical problems defined earlier on in the description, to which problems the notable features defined hereinabove do not necessarily contribute. The latter may form the subject matter, as appropriate, of one or more divisional patent applications.

According to one embodiment of the invention, the two side walls are opposite or facing side walls.

According to one embodiment of the invention, the spacer is configured to be in contact with the adjacent large side faces of said cells, and comprises a flow zone arranged to be situated facing the adjacent large side faces of the cells and to extend over the majority of said large faces, one or more ribs extending in the flow zone, the ribs or ribs being arranged so as to form at least one forced-circulation circuit for the heat-transfer fluid between said cells (10), preferably such that the fluid is in contact with the two adjacent large side faces of said cells, the forced-circulation circuit comprises an inlet and an outlet.

According to one embodiment of the invention, the inlet and outlet collectors both extend along at least one side wall of the housing.

The positioning of the collectors along at least one of the side walls allows a reduction in the size of the thermal regulation device.

According to one embodiment of the invention, the inlet and outlet collectors both extend along the same side wall of the housing.

The positioning of the collectors along the same side wall allows a reduction in the size of the battery housing, in particular in the width direction of said housing.

According to one embodiment of the invention, the outlet collector is situated above the inlet collector.

The presence of the outlet collector above the inlet collector can facilitate the circulation of the fluid because of variations in its density when hot or cold. In fact, the hot heat-transfer fluid will rise while the cold heat-transfer fluid, which is heavier, falls in the circulation circuit. Thus, when the cells of the battery have heated the fluid, the positioning of the outlet collector in height can facilitate the movement of the fluid from the inlet collector towards the outlet collector, and hence maintain a constant cooling of the cells.

According to one embodiment of the invention, the inlet and outlet collectors extend respectively along each of the two side walls.

This embodiment allows a reduction in the size of the housing in the height direction.

Advantageously, the two collectors are situated at the same height or level against or on their respective side wall.

Preferably, the two collectors are positioned against the side walls and close to the top wall of the housing. Advantageously, the heat-transfer fluid is supplied into the inlet collector in a direction opposite the circulation direction of the heat-transfer fluid which is discharged from the outlet collector. This circulation direction allows a further reduction in the size of the thermal regulation device, all elements of said device being positioned on a same side of the battery pack.

According to one embodiment of the invention, the battery pack also comprises busbars situated in an upper space formed between the battery cells and the top wall of the housing, and one of said collectors of the device, advantageously the inlet collector, extends along one of the side walls while the other collector is formed, at least in part, by the upper space.

Advantageously, one of said collectors is liable to be formed by the upper space. If one of the collectors is formed partially in the upper space provided between the cells and the top wall of the housing, the cooling of the busbars is improved thanks to the passage of the heat-transfer fluid close thereto. The presence of a single collector on the side wall also allows a reduction in the size of the thermal regulation device.

Advantageously, the top wall has an orifice to allow a fluidic communication of the heat-transfer fluid present in the circulation circuit with the upper space.

Advantageously, the circulation circuit for the heat-transfer fluid comprises or is connected to at least one pump which can facilitate the circulation of said fluid in the circuit. The pump of the thermal regulation device improves the movement of the heat-transfer fluid in the circulation circuit, and hence allows better cooling of the cells.

According to one embodiment of the invention, the fluidic connection between a collector and the spacer is achieved by the addition of a piece or by extension of the spacer allowing the spacer to be held on the cell.

Advantageously, each battery cell comprises four side faces: two large side faces, of which at least one is oriented towards one of the large side faces of the adjacent cell, and two small side faces connecting the two large side faces together. Advantageously, the spacer is extended onto the small side walls of the cell by small support zones. The positioning of the spacer can facilitate the mounting and support of said spacer on the battery cell.

According to one embodiment of the invention, the circulation circuit for the heat-transfer fluid comprises fluid circulation sections of variable width, these circulation sections of variable width preferably being formed by the spacer.

The difference in width of the circulation sections of the circulation circuit allows the coefficient of thermal exchange between the heat-transfer fluid and the cell to remain constant along said circuit, and hence allows the same cooling efficacy irrespective of the location of the cell in contact with said fluid.

According to one embodiment, the circulation circuit for the heat-transfer fluid comprises fluid circulation sections of width which decreases, preferably gradually or continuously, from the inlet collector towards the outlet collector.

More specifically, a decreasing width of the circulation sections allows the cooling efficacy of the cells to remain the same, thanks to the increase in speed of circulation of the heat-transfer fluid in said sections.

According to one embodiment of the invention, the decreasing width of the fluid circulation sections from the inlet collector towards the outlet collector is between −20% and −80%, preferably between −40% and −60%.

According to one embodiment of the invention, the spacer is clipped onto at least one battery cell or bonded to at least one battery cell.

These two fixing methods, clipping or bonding, allow simplification of the fixing and mounting of the spacer on the cell. These fixing methods also allow a reduction in the size of the spacer and of the circulation circuit in the housing. These fixings can also facilitate the handling and assembly of the spacers on the cells. The fixing of the spacer on the cell also allows an optimum seal against the heat-transfer fluid.

According to one embodiment, when the spacer is bonded, the spacer is formed from a plurality of segments or independent elements.

The term “independent elements” means that the spacer is formed from multiple elements which are not connected to one another and which form the circulation circuit. This can simplify the spacer, and facilitate its mounting and bonding to the face of the corresponding battery cell.

Advantageously, the spacer is made from a material having a thermal conductivity of at most 0.4 W·m⁻¹·K⁻¹, preferably at most 0.2 W·m⁻¹·K⁻¹. Preferably, the spacer is made of a polymer material or a polymer-based composite material, such as a flame-retardant polyamide. Further preferably again, the spacer contains a material from the silicate family, preferably being made of fiber-reinforced calcium silicate. These materials must be rigid to allow their mounting, and as far as possible prevent thermal conductivity so that this is limited to the heat-transfer fluid, and not transmitted via the spacers from one cell to another.

The invention also relates to a cooling system comprising a thermal regulation device according to the invention, and also comprising: a battery pack comprising N adjacent battery cells, including two end cells each arranged at one end wall of the housing, N being a whole number greater than 3, the device comprising at least N−1 spacers, preferably N+1 spacers.

The cooling system is designed such that a spacer is installed between two adjacent cells so as to cool all the large side faces of said cells.

According to one embodiment of the invention, a spacer is installed between each cell that is adjacent to another cell; a spacer is installed between each end wall of the housing and the end cell, a large side face of which is adjacent to said wall; the spacers are in contact with the adjacent large side faces of said battery cells, such that all the large side faces of the cells are cooled by the circulation circuit for the heat-transfer fluid.

This configuration allows an effective cooling of all the large side faces of the battery pack cells, by also positioning a spacer between the end wall of the housing and the large side face of the adjacent end cell. Preferably, the inlet and outlet collectors supply or discharge the heat-transfer fluid to or from each portion of the circulation circuit situated on each of the spacers.

According to one embodiment of the invention, the N adjacent cells of the battery pack form two or more rows of cells placed side by side; each spacer comprises ribs shaped so as to create one or more forced-circulation circuits, each said circuit having one or more passes straddling the two large side faces of two cells arranged side by side; each spacer comprises a median rib which extends in the height of said cells and which, during use, lies between the lateral edges of said large side faces, such that said median rib fills the space between the two cells and forms a seal between said cells.

This embodiment is particularly suitable for devices in which the inlet and outlet collectors are positioned on a single side wall of the housing. The formation of each pass straddling the two side-by-side cells allows the temperature to remain as homogeneous as possible.

According to one embodiment of the invention, openings are provided in the median rib so as to allow the circulation of fluid between the large side faces of two cells arranged side by side.

According to one embodiment of the invention, an inlet collector and/or an outlet collector are extended and elbowed so as to open directly into the forced-circulation circuit formed at the level of at least one of the end cells.

Alternatively, the median rib may not be present, or may be present only in part, so as to allow the circulation of fluid between the side-by-side cells. This embodiment is particularly suitable for devices in which the inlet and outlet collectors are positioned on each of the two side walls of the housing. The space between the two cells then forms an intermediate collector which facilitates the distribution of the fluid between the cells.

In general, the presence of a spacer positioned between two adjacent cells allows the spacing between said cells to be kept constant, limiting the risk of their coming into contact in the case of swelling. As the spacer comprises the circulation circuit, it also allows the heat-transfer fluid to be in permanent contact with the cells. These spacers also serve to apply a minimal compression rate to said cells, so as to limit their possible swelling.

### BRIEF DESCRIPTION OF THE FIGURES

Further advantages and features of the invention will become more clearly apparent upon reading the following description of a preferred embodiment, with reference to the appended drawings, which are provided by way of non-limiting indicative examples and in which:

FIG. 1a is an exploded, perspective view of a battery pack integrated into a housing according to the invention, for a motor vehicle.

FIG. 1b shows a perspective view of a battery cell according to the invention.

FIG. 2 is a simplified schematic representation of a thermal regulation device for a battery pack according to the invention.

FIG. 3a is a cross-sectional view of a thermal regulation device at a spacer, said device being in accordance with a first embodiment of the invention.

FIG. 3b is a perspective view of the spacer mounted on a battery cell according to the first embodiment of the invention.

FIG. 4a is a cross-sectional view of a thermal regulation device at a spacer, said device being in accordance with a second embodiment of the invention.

FIG. 4b is a perspective view of the spacer mounted on a battery cell according to the second embodiment of the invention.

FIG. 5 is a cross-sectional view of a thermal regulation device at a spacer, said device being in accordance with a third embodiment of the invention.

FIG. 6 is a cross-sectional view of a thermal regulation device at a spacer, said device being in accordance with a fourth embodiment of the invention.

FIG. 7 is a cross-sectional view of a thermal regulation device at a spacer, said device being in accordance with a fifth embodiment of the invention.

FIG. 8 is a cross-sectional view of a thermal regulation device at a spacer, said device being in accordance with a sixth embodiment of the invention.

FIG. 9 is a perspective view of the spacer mounted on a battery cell, according to a seventh embodiment of the invention.

FIG. 10 is a battery pack comprising two rows of cells placed side by side.

FIG. 11 is a possible configuration of a spacer for the battery pack of FIG. 10.

FIG. 12 illustrates a possible configuration of fluid inlet and outlet collectors.

### DESCRIPTION OF THE EMBODIMENTS

As used herein, and unless stated otherwise, the use of the ordinal adjectives “first”, “second”, etc., to describe an object merely indicates that different instances of similar objects are being referred to and does not imply that the objects so described must be in any given sequence, whether in time, space, order of rank, etc. “X and/or Y” means: X alone or Y alone or X+Y. In general, it will be appreciated that, in the various attached figures, the objects have been drawn arbitrarily to make the drawings easier to read.

The thermal regulation device which is the subject matter of the invention seeks to regulate the temperature of a battery pack, in particular the battery pack of an electric and/or hybrid motor vehicle. However, it may be fitted to other types of vehicles, or used to regulate the temperature of other electrical and/or electronic components such as power electronics elements, for example and non-limitingly, semiconductors, such as diodes or transistors. These could also be components of computer servers. According to one preferred embodiment, the thermal regulation consists in cooling the cells of the battery pack.

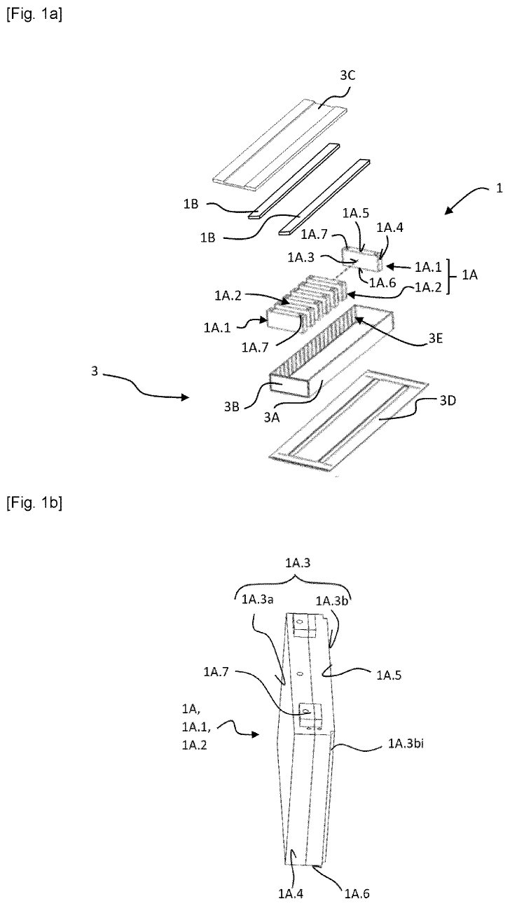

FIGS. 1a and 1b show perspective views of a battery pack and a battery cell according to the invention.

A battery pack 1 comprises at least two battery cells 1A and is housed in a housing 3. More generally, the battery pack 1 comprises between 2 and 25 cells 1A. According to one embodiment, the battery pack 1 comprises N adjacent cells 1A, where N is a whole number greater than 2 and preferably greater than 3. The cells 1A comprise two end cells 1A.1 arranged at each of the ends of the battery pack 1, and in some cases central cells 1A.2 positioned between the two end cells 1A.1. The central cells 1A.2 and end cells 1A.1 are generally identical in form, so for simplification reasons, only the form of one cell 1A will be described below and may represent the form of either a central cell 1A.2 or an end cell 1A.1.

In general, the battery cells 1A are preferably prismatic, i.e. generally parallelepipedic in form, but may also take any form known to the person skilled in the art. When the cell 1A is prismatic, it comprises two large side faces 1A.3, two small side faces 1A.4, a top face 1A.5 and a bottom face 1A.6. These various faces (1A.3, 1A.4, 1A.5, 1A.6) are generally planar but some of them may be curved inwardly or outwardly.

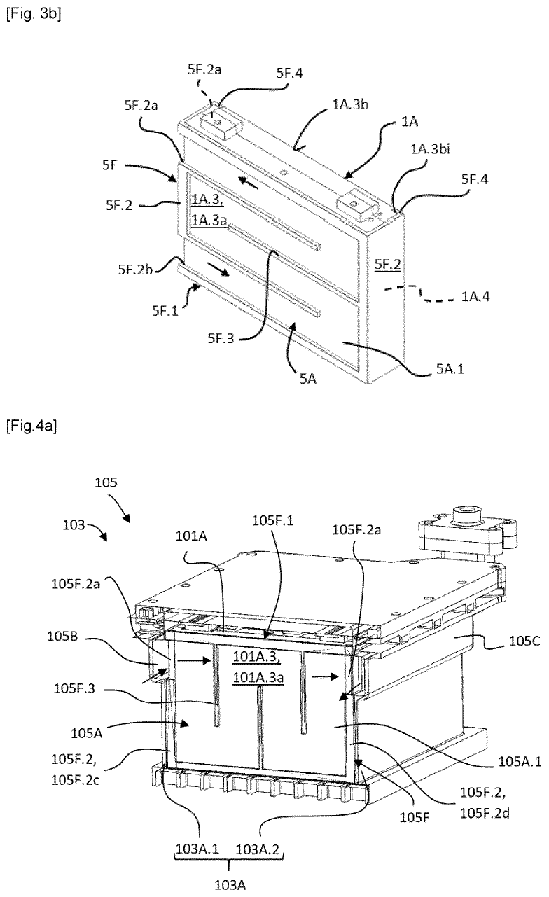

More specifically, in FIG. 1b, the cell 1A is preferably oriented. Oriented here means that the two large side faces 1A.3 are not strictly identical. In fact, a first large side face 1A.3a extends between the two small side faces 1A.4 and is substantially planar. A second large side face 1A.3b is positioned facing the first face 1A.3a, and has at least one notch 1A.3bi at its junction with one of the small side faces 1A.4. Preferably, the second large side face 1A.3b has two notches 1A.3bi at each junction with each small side face 1A.4 of the cell 1A. The function of said notches 1A.3bi will be described in FIG. 3b. However, in certain configurations of the cells 1A, the notches 1A.3bi may not be present.

Each cell 1A also has two terminals 1A.7, positive and negative, for the electrical connection. More specifically, each cell 1A is connected in series, via its terminals 1A.7, to the terminals 1A.7 of the adjacent cells 1A, by means of busbars 1B (also known as a “bar set” or “omnibus bar”). The busbars 1B of the battery pack 1 extend in an upper space 3E formed between the cells 1A of the battery pack 1 and the top wall 3C of the housing 3, either between the positive terminals 1A.7 or between the negative terminals 1A.7 of the two end cells 1A.1.

The housing 3 containing the battery pack 1 comprises two side walls 3A and two end walls 3B, said walls (3A, 3B) being closed at their upper ends by a top wall 3C and at their lower ends by a bottom wall 3D. Thus, the housing 3 forms a sealed enclosure which is configured to receive one or more battery packs 1. Advantageously, the two side walls 3A are opposite or facing side walls 3A. The cells 1A of the battery pack 1 are preferably positioned in the longitudinal direction of the housing 3, i.e. the large side faces 1A.3 of the cells 1A are positioned parallel to the end walls 3B of the housing 3. Thus, each end cell 1A.1 is arranged at an end wall 3B; more specifically, one of the large side faces 1A.3 of the end cell 1A.1 is adjacent to one of the end walls 3B of the housing 3. The rest of the cells 1A are then positioned in adjacent fashion at their large side faces 1A.3.

In these figures, the housing 3 is of generally parallelepipedic shape, but other suitable shapes may be envisioned, depending in particular on the general shape of the battery pack 1. According to one embodiment, the walls (3A, 3B, 3C, 3D) may be produced by molding a plastic material, but other materials deemed suitable by those skilled in the art may be used. This housing 3 forms part of a thermal regulation device of a battery pack 1.

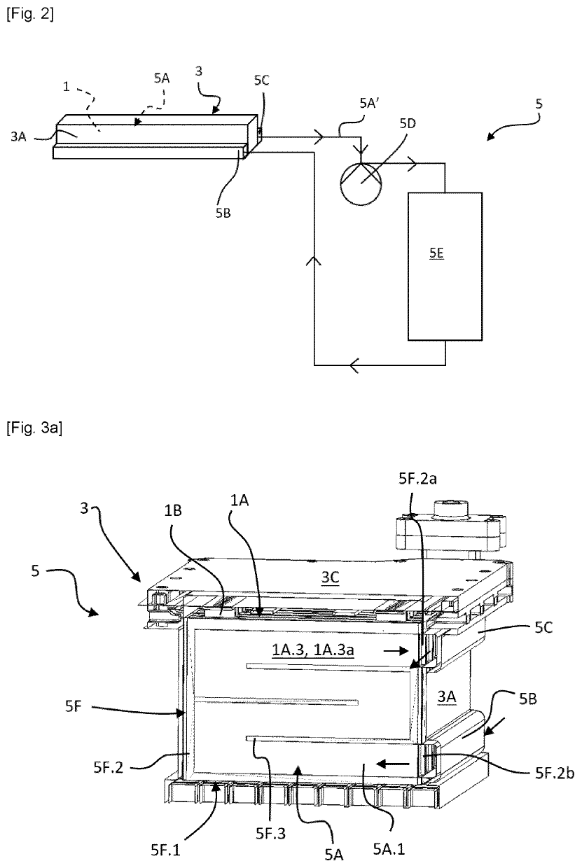

FIG. 2 is a schematic representation of a part of the thermal regulation device according to the invention.

As mentioned above, it is necessary to regulate the temperature of the battery pack 1 in order to limit the risk of damage to the cells (the cells not being shown in FIG. 2). For this reason, the thermal regulation device 5 is important for proper function of the battery block 1.

This thermal regulation device 5 comprises a circulation circuit 5A for a heat-transfer fluid, said fluid being held around the battery pack 1 thanks to the sealed enclosure formed by the housing 3. The circulation circuit 5A is preferably designed to pass between the cells of the battery pack 1 for thermal regulation thereof.

The thermal regulation device 5 also comprises an inlet collector 5B which supplies the heat-transfer fluid to the circulation circuit 5A, and an outlet collector 5C which discharges said fluid from said circuit 5A. This device 5 also comprises a pump 5D which will facilitate circulation of the heat-transfer fluid in the circulation circuit 5A. The pump 5D allows the heat-transfer fluid to be set in circulation from a reservoir 5E, via an external circulation circuit 5A′ to the housing 3, the external circulation circuit 5A′ connecting said reservoir 5E to the housing 3 of the battery pack 1. Thus, the pump 5D is connected to the circulation circuit 5A. The arrows shown on the external circuit 5A′ indicate the direction of circulation of the heat-transfer fluid. Alternatively, the pump 5D may be contained in the circulation circuit 5A, this embodiment not being shown in the figures. In this figure, the collectors (5B, 5C) are positioned on the side walls 3A of the housing 3.

Particularly advantageously, the inlet collector 5B may comprise a sieve, said sieve being configured to filter the heat-transfer fluid so as to avoid the circulation of particles in said fluid (the sieve not being shown on these figures). These particles also have the drawback of reducing the efficacy of the heat-transfer fluid. This sieve is therefore preferably placed at the inlet to the inlet collector 5B and/or in at least a part of said collector 5B, upstream of the arrival of the heat-transfer fluid within the circulation circuit 5A. Advantageously, the sieve may be of generally cylindrical form. Alternatively, the sieve may have the shape of the collector 5B. The sieve is generally formed by a rigid structure, produced in particular in a plastic or metallic material, in the form of a net or frame. This net serves to support a mesh grid able to allow filtration of particles preferably smaller than 200 μm, more preferably smaller than 50 μm. The mesh grid is advantageously made of metallic material.

The following FIGS. 3 to 9 show various embodiments of a spacer according to the invention.

In general, the spacers are designed to be positioned between two adjacent cells of the battery pack. The purpose of the spacers is to keep the cells spaced apart from one another, at a defined distance. They also allow application of a compression to said cells, so as to avoid their swelling in the case of overheating.

In the thermal regulation device (5; 105; 205; 305; 405; 505) according to the invention, spacers (5F; 105F; 205F; 305F; 405F; 505F; 605F; 705F) are installed between two adjacent cells (1A; 101A; 201A; 301A; 401A; 501A; 601A; 701A, 701A′). Thus, the device (5; 105; 205; 305; 405; 505) comprises at least N−1 spacers (5F; 105F; 205F; 305F; 405F; 505F; 605F; 705F), N being the number of cells (1A; 101A; 201A; 301A; 401A; 501A; 601A; 701A, 701A′) present in the battery pack (1; 701). Preferably, the thermal regulation device (5; 105; 205; 305; 405; 505) comprises N+1 spacers (5F; 105F; 205F; 305F; 405F; 505F; 605F; 705F). In fact, preferably, an additional spacer is advantageously provided between one of the end cells 1A.1 and the adjacent end wall 3B of the housing (3; 103; 203; 303; 403; 503; 703), this particular installation not being specifically shown in the figures. The spacers (5F; 105F; 205F; 305F; 405F; 505F; 605F; 705F) are thus in contact with the adjacent large side faces (1A.3; 101A.3; 201A.3; 301A.3; 401A.3; 501A.3; 601A.3; 701A.3, 701A′.3) of the battery cells (1A; 101A; 201A; 301A; 401A; 501A; 601A; 701A, 701A′). Yet more preferably, the thermal regulation device (5; 105; 205; 305; 405; 505) comprises N+2 spacers (5F; 105F; 205F; 305F; 405F; 505F; 605F; 705F), two additional spacers being provided between each of the two end cells 1A.1 and the corresponding end wall 3B of the housing (3; 103; 203; 303; 403; 503; 703).

In all embodiments of the invention, the spacers (5F; 105F; 205F; 305F; 405F; 505F; 605F; 705F) also define a portion of the circulation circuit (5A; 105A; 205A; 305A; 405A; 505A; 705A) for the heat-transfer fluid. Thus the presence of the spacers (5F; 105F; 205F; 305F; 405F; 505F; 605F; 705F) in contact with the large side faces (1A.3; 101A.3; 201A.3; 301A.3; 401A.3; 501A.3; 601A.3; 701A.3, 701A′.3) of each battery cell (1A; 101A; 201A; 301A; 401A; 501A; 601A; 701A, 701A′) allows a cooling of said large faces (1A.3; 101A.3; 201A.3; 301A.3; 401A.3; 501A.3; 601A.3; 701A.3, 701A′.3) by the circulation circuit (5A; 105A; 205A; 305A; 405A; 505A; 705A) for the heat-transfer fluid. The inlet of the heat-transfer fluid into the circulation circuit (5A; 105A; 205A; 305A; 405A; 505A; 705A) is achieved via an inlet collector (5B; 105B; 205B; 305B; 405B; 505B; 705B), and the outlet of said fluid is achieved via an outlet collector (5C; 105C; 205C; 305C; 405C; 505C; 705C). At least one collector (5B, 5C; 105B, 105C; 205B, 205C; 305B, 305C; 405B, 405C; 505B, 505C; 705B, 705C) extends along at least one of the side walls (3A; 103A; 203A; 303A; 403A; 503A) forming the housing (3; 103; 203; 303; 403; 503; 703). According to another embodiment, the collectors (5B, 5C; 105B, 105C; 205B, 205C; 305B, 305C; 405B, 405C; 505B, 505C; 705B, 705C) extend along at least one of the side walls (3A; 103A; 203A; 303A; 403A; 503A) forming the housing (3; 103; 203; 303; 403; 503; 703). In some cases, one of the collectors (5B, 5C; 105B, 105C; 205B, 205C; 305B, 305C; 405B, 405C; 505B, 505C; 705B, 705C) may be formed by the upper space (3E; 203E; 303E) of the housing (3; 103; 203; 303; 403; 503; 703).

Advantageously, the spacers (5F; 105F; 205F; 305F; 405F; 505F; 605F; 705F) also have a relatively low thermal conductivity, so as to act as thermal insulators between the cells (1A; 101A; 201A; 301A; 401A; 501A; 601A; 701A, 701A′). Preferably, the spacers (5F; 105F; 205F; 305F; 405F; 505F; 605F; 705F) are made of a material having a thermal conductivity of at most 0.4 W·m⁻¹·K⁻¹, preferably a thermal conductivity of at most 0.2 W·m⁻¹·K⁻¹. The material used may be a polymer or polymer-based composite material, such as a fire-retardant polyamide, or a material from the silicate family, preferably being made of fiber-reinforced calcium silicate.

In general, the heat-transfer fluid used is preferably a dielectric liquid, for example a mineral oil or fluorinated liquid. The heat-transfer fluid may, however, be in some other form, for example the form of blown air. The fluid may be precooled or preheated according to the thermal regulation intended.

FIGS. 3a and 3b show respectively a cross-sectional view of a spacer of the battery pack mounted in the housing according to a first embodiment of the invention, and a perspective view of said spacer mounted on a cell.

In this first embodiment of the invention, the inlet collector 5B and the outlet collector 5C of the heat-transfer fluid extend along the same side wall 3A of the housing 3 of the thermal regulation device 5. The outlet collector 5C is preferably positioned above the inlet collector 5B. This positioning can facilitate the movement of the heat-transfer fluid through the circulation circuit 5A. In fact, when the heat-transfer fluid has performed its function as a heat exchanger, it will be hotter and hence less dense, and will spontaneously tend—independently of the function of the pump mentioned in FIG. 2—to rise along the circulation circuit 5A. Preferably, the collectors (5B, 5C) are formed in the corresponding side wall 3A. Further preferably, the collectors (5B, 5C) are formed in the side wall 3A of the housing 3 by deep-drawing.

In this embodiment, the heat-transfer fluid circulates in the collectors (5B, 5C) in the same direction. Thus if the fluid inlet is arranged on one of the end walls of the housing 3 (said end walls not being visible on these figures), the outlet of the heat-transfer fluid is then arranged at the other end wall. The direction of circulation of the heat-transfer fluid is indicated in FIGS. 3a and 3b by arrows.

These figures also show one of the spacers 5F positioned against a cell 1A. Each spacer 5F defines a portion of the circulation circuit 5A for the heat-transfer fluid, wherein all parts on each of the spacers 5F present in the housing 3 form the circulation circuit 5A. The structure of a spacer 5F according to the invention has an overall form of a U-shaped channel, and may take the form of a single piece. The spacer 5F also has a large support zone 5F.1 configured to come to rest against the large side face 1A.3 of the cell 1A, and more particularly against the first large side face 1A.3a of the cell 1A. The spacer 5F also comprises two small support zones 5F.2 configured to come to bear against the small side faces 1A.4 of said cell 1A, and each oriented towards one of the side walls 3A of the housing 3. The small support zones 5F.2 form an extension of the spacer 5F which allow it to be held on the cell 1A.

When the cells 1A are installed in the housing 3 in the usage configuration, the large support zone 5F.1 comes to bear not only against the large side face 1A.3 of the cell 1A against which the spacer 5F is installed (hereinafter referred to as the “front” large side face) but also comes to bear against the large side face of the adjacent cell (hereinafter referred to as the “rear” large side face). The large support zone 5F.1 is thus sandwiched between the adjacent large side faces 1A.3 of the cells 1A. According to a preferred embodiment, the contacts between the large support zone 5F.1 and the front and rear large side faces 1A.3 of the adjacent cells 1A are contacts that are fluid-tight.

The large support zone 5F.1 has the same dimensions, or substantially the same dimensions, in terms of length and width, as those of a large side face 1A.3 of the cell 1A. It defines a circulation section 5A.1 of the heat-transfer fluid which is situated facing the large side face 1A.3 of the cell 1A against which the spacer 5F is installed, and which extends over the majority of said large side face 1A.3. Symmetrically, this circulation section is also located opposite the large rear side face of the adjacent cell, so that the heat-transfer fluid flowing in said section 5A.1 is in contact with the two large side faces 1A.3 of the adjacent cells 1A.

According to a preferred embodiment of the invention, the circulation section 5A.1 extends over at least 51%, advantageously at least 90% and preferably at least 95% of the surface of the adjacent large side faces 1A.3. The majority of these large side faces 1A.3 can thus be in contact with the heat-transfer fluid, as explained earlier in the description.

Each spacer 5F also comprises one or more horizontal ribs 5F.3 which extend in the perforated part of the circulation section 5A.1 and are arranged so as to form a portion of the forced-circulation circuit 5A for the heat-transfer fluid between the adjacent cells 1A. The term “forced circulation” means that the fluid is forced to follow a specific path, from bottom to top, imposed by the arrangement of the rib or ribs 5F.3. This or these circuit portions 5A are thus bounded firstly by the adjacent large side faces 1A.3 of the cells 1A and secondly by the ribs 5F.3. All the large side faces 1A.3 of the cells 1A are thus cooled by the forced-circulation circuit 5A. The number of passes (i.e. direction changes in a portion of the forced-circulation circuit 5A) is tailored to suit the desired level of heat exchange and/or to suit the permissible pressure drop. The best results in terms of heat exchange are obtained when the portion of the forced-circulation circuit 5A has at least one change of direction of the fluid, advantageously at least 3 changes of direction of the fluid.

At least one or more orifices (5F.2a, 5F.2b) are also arranged on the spacer 5F, each orifice opening respectively into the inlet collector 5B and into the outlet collector 5C of the thermal regulation device 5. In FIGS. 3a and 3b, one of the small support zones 5F.2 of the spacer 5F has one or more upper orifices 5F.2a and one or more lower orifices 5F.2b, each adapted to establish fluidic communication between the portion of the circulation circuit 5A and the collectors (5B, 5C). In FIG. 3a, the lower orifice 5F.2b ensures the inlet of the fluid into the portion of the circulation circuit 5A from the inlet collector 5B, and the upper orifice 5F.2a allows the outlet of the fluid from said portion of the circuit 5A towards the outlet collector 5C. This arrangement advantageously allows the use of smaller collectors. More specifically, the sum of the heights of the two collectors (5B, 5C) is less than the height of the adjacent cell 1A.

Each spacer 5F also has a structure which is configured to be removably installed on the cell 1A, preferably by clipping or bonding. According to one embodiment, the structure of the spacer 5F is adjusted (for example by elastically deforming said structure) to suit the shape of the cell 1A so that it can be mounted tightly on said cell 1A, such that the contacts between said structure and said cell 1A are contacts that are fluid-tight.

The two small support zones 5F.2 may also be extended towards the rear by rear support zones 5F.4. These rear support zones 5F.4 serve to allow clipping of the spacer 5F on the cell 1A. In order to retain the seal of the portion of the circulation circuit 5A situated between two adjacent cells 1A, these rear support zones 5F.4 are configured to each be inserted in one of the notches 1A.3bi of the second large side face 1A.3b of the cell 1A. However, in the same way as for the notches 1A.3bi, the rear support zones 5F.4 may not be found on the spacer 5F. The spacer 5F is then clipped to the cell 1A solely by means of the small support zones 5F.2 and by means of the compression of said cells 1A. Alternatively, a spacer 5F of this type may also be bonded.

The circulation of the heat-transfer fluid within the thermal regulation device is described below. In this embodiment of the invention, the heat-transfer fluid thus arrives via the inlet collector 5B, preferably positioned on or against the lower end of one of the side walls 3A, and enters the circulation circuit 5A by means of the lower orifice 5F.2b positioned at one of the small support zones 5F.2 of the spacer 5F. The heat-transfer fluid circulates in the circulation sections 5A.1 of said circuit 5A, which are formed in particular by the ribs 5F.3, towards the upper orifice 5F.2a situated on the same small support zone 5F.2 of the spacer 5F. The heat-transfer fluid will then be able to exit the housing 3 via the outlet collector 5C positioned laterally on the same side wall 3A of the housing 3. The support zones 5F.2 will thus also allow the fluidic connection between said spacer 5F and the collectors (5B, 5C). Alternatively, this fluidic connection could be achieved via a separate part. This embodiment is particularly advantageous for reducing the height and width of the housing 3 containing the battery pack, by positioning the two collectors (5B, 5C) on a same side of said housing 3.

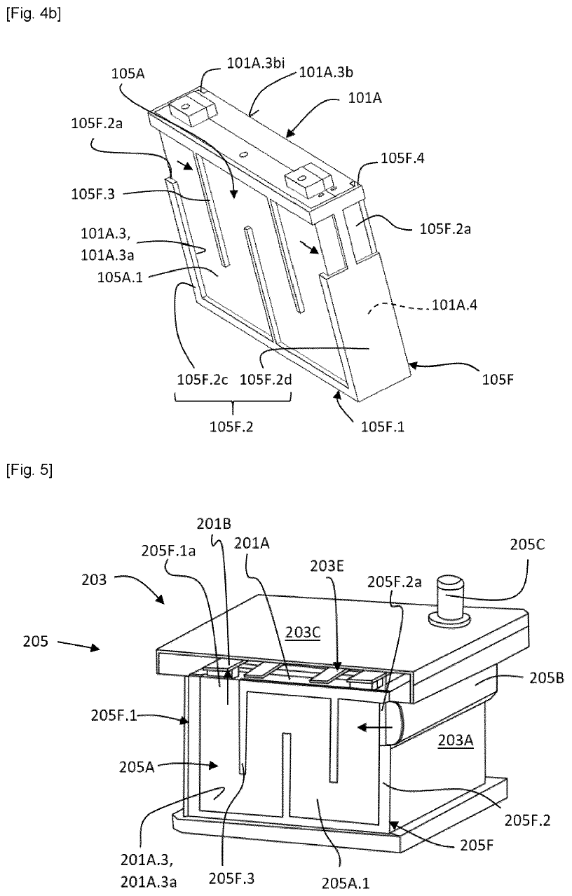

FIGS. 4a and 4b show respectively a cross-sectional view of a spacer of the battery pack mounted in the housing according to a second embodiment of the invention, and a perspective view of said spacer. These figures repeat the numbering in preceding figures for identical or similar elements, but with the numbering being incremented by 100. Reference is also moreover made to the description of these elements that was given with regard to the first embodiment of the invention. We will concentrate below on the differences between the first embodiment of the invention and the second embodiment of the invention.

In this second embodiment of the invention, the inlet collector 105B and the outlet collector 105C of the heat-transfer fluid extend along each of the two side walls 103A of the housing 103 of the thermal regulation device 105. The two collectors (105B, 105C) are preferably positioned at the same height or at the same level of the side walls 103A, and are preferably positioned against or on their respective side wall 103A. Preferably, the collectors (105B, 105C) are formed in the corresponding side wall 103A. Further preferably, the collectors (105B, 105C) are positioned in the upper ends of the side walls 103A.

In this embodiment, the heat-transfer fluid circulates in the collectors (105B, 105C) in opposite directions. Thus, the inlet and outlet of the heat-transfer fluid are positioned on the same end wall (the end walls not being visible in these figures) of the housing 103. The direction of circulation of the heat-transfer fluid is indicated in FIG. 4a by arrows.

Furthermore, the structure of the spacer 105F also has an overall form of a U-shaped channel, and takes the form of a single piece. As before, the spacer 105F has a large support zone 105F.1 configured to come to bear against the large side face 101A.3 of the cell 101A, preferably the first large side face 101A.3a of the cell 101A, and two small support zones 105F.2 configured to come to bear against the small side faces of said cell 101A (the small side faces not being visible in FIGS. 4a and 4b). The positioning of the spacer 105F relative to the adjacent cells 101A is similar to that indicated above in the first embodiment of the invention. The large support zone 105F.1 also defines a circulation section 105A.1 of the heat-transfer fluid, which determines a circulation of said fluid along the large side faces 101A.3 of the adjacent cells 101A, in a direction which this time is vertical.

As before, the small support zones 105F.2 may also be extended towards the rear by rear support zones 105F.4, which lie in one of the notches 101A.3bi of the second large side face 101A.3b of the cell 101A. However, in the same way as for the preceding embodiment, the rear support zones 105F.4 and the notches 101A.3bi may not be found on the spacer 105 and on the cell 101A respectively. The differences between these two embodiments lie in the configuration of the spacer 105F. In fact, each spacer 105F comprises one or more vertical ribs 105F.3 which extend in the perforated part of the circulation section 105A.1 and are arranged so as to form a portion of the forced-circulation circuit 105A for the heat-transfer fluid between the adjacent cells 101A. This forced circulation is possible from a first side wall 103A.1 towards a second side wall 103A.2 of the housing 103. This or these circuit portions 105A are thus bounded firstly by the adjacent large side faces 101A.3 of the cells 101A and secondly by the ribs 105F.3. The number of passes (i.e. direction changes in a portion of the forced-circulation circuit 105A) is also tailored to suit the desired level of heat exchange and/or to suit the permissible pressure drop. The best results in terms of heat exchange are obtained when the portion of the forced-circulation circuit 105A has at least one change of direction of the fluid, advantageously at least 3 changes of direction of the fluid.

There are differences concerning at least one or more orifices 105F.2a which are arranged on the spacer 105F. Each of the orifices opens respectively into the inlet collector 105B and into the outlet collector 105C. Each of the two small support zones 105F.2 of the spacer 105F has one or more upper orifices 105F.2a suitable for allowing passage of the heat-transfer fluid. Preferably, the upper orifice 105F.2a of a first small support zone 105F.2c allows the fluid to be supplied to the circulation circuit 105A, while the upper orifice 105F.2a of a second support zone 105F.2d allows discharge of said fluid from the circulation circuit 105A.

In this second embodiment of the invention, the circulation of the heat-transfer fluid is also different. In fact, the heat-transfer fluid arrives via the inlet collector 105B which is preferably positioned on or against an upper end of one of the side walls 103A of the housing 103. The fluid then enters the circulation circuit 105A via the upper orifice 105F.2a positioned on the first small support zone 105F.2c of the spacer 105F. Said fluid then circulates in the circulation sections 105A.1 of said circuit 105A, said sections 105A.1 being formed against the large side face 101A.3 of the adjacent cells 101A. The heat-transfer fluid then circulates towards the upper orifice 105F.2a situated on the second small support zone 105F.2d of the spacer 105F, and will be able to exit the housing 103 via the outlet collector 105C. This embodiment is particularly advantageous for reducing the size of the housing 103 in height.

FIG. 5 shows a cross-sectional view of a spacer and the battery pack mounted in the housing according to a third embodiment of the invention. This figure repeats the numbering in preceding figures for identical or similar elements, but with the numbering being incremented by 100 relative to the second embodiment of the invention. Reference is also moreover made to the description of these elements that was given with regard to the preceding embodiments of the invention. We will concentrate below on the differences between the preceding embodiments and the third embodiment of the invention.

In this embodiment of the invention, a single inlet collector 205B of the thermal regulation device 205 extends along one of the side walls 203A of the housing 203. The outlet collector 205C is formed, at least in part, by the upper space 203E of the housing 203, and may be positioned at any point on the upper wall 203C of said housing 203. More preferably, in order to achieve the most effective cooling possible with a cooling fluid which circulates in the entire upper space 203E, the outlet collector 205C is positioned at one end of the housing 203, on the side of the inlet collector 205B. The outlet collector 205C communicates with the upper space 203E and the circulation circuit 205A via an orifice, which is not shown in this figure. This orifice allows passage of the heat-transfer fluid. Alternatively, the collector that extends along one of the side walls may be the outlet collector. It will then be the inlet collector which will be formed, at least in part, by the upper space of the housing. This variant is not specifically shown on these figures.

In this embodiment of the invention, the spacer 205F also has vertical ribs 205F.3 on the large support zone 205F.1, at one of the large side faces 201A.3 of one of the cells 201A, more specifically the first large side face 201A.3a of said cell 201A. These ribs 205F.3 will delimit the circulation sections 205A.1 of the heat-transfer fluid at the surface of adjacent cells 201A, so as to allow an effective cooling of the large side faces 201A.3 of the cells 201A. In the same way as before, the spacer 205F is positioned between two adjacent cells 201A and is pressed against said cells 201A so as to allow the sealed circulation of the heat-transfer fluid.

At least one or more orifices 205F.2a are arranged on the spacer 205F, each of the orifices 205F.2a opening into the inlet collector 205B. The spacer 205F also has an upper outlet orifice 205F.1a, positioned on an upper edge of the spacer 205F and at the opposite end to the upper orifice 205F.2a positioned in the small support zone 205F.2 in contact with the lateral inlet collector 205B.

In this embodiment of the invention, the heat-transfer fluid arrives via the inlet collector 205B, preferably positioned on or against the upper end of one of the side walls 203A, and enters a portion of the circulation circuit 205A by means of the upper orifice 205F.2a, positioned at the small support zone 205F.2 of the spacer 205F. The heat-transfer fluid circulates in the circulation sections 205A.1 of said circuit portion 205A, which are formed against the large side face 201A.3 of the adjacent cells 201A, towards the upper outlet orifice 205F.1a situated at an opposite end of the spacer 205F of the inlet collector 205B. This orifice 205F.1a is positioned at the large support zone 205F.1 on the upper edge of said zone 205F.1. Thus, the heat-transfer fluid will be able to flow at the level of the upper space 203E of the housing 203. In particular, it can circulate above and around the busbars 201B. The heat-transfer fluid will then be able to exit the housing 203 via an orifice provided for this purpose in the upper wall 203C of said housing 203, extended by the outlet collector 205C. This embodiment is particularly advantageous if it is desirable to provide, in addition to cooling of the cells 201A, a cooling of the busbars 201B.

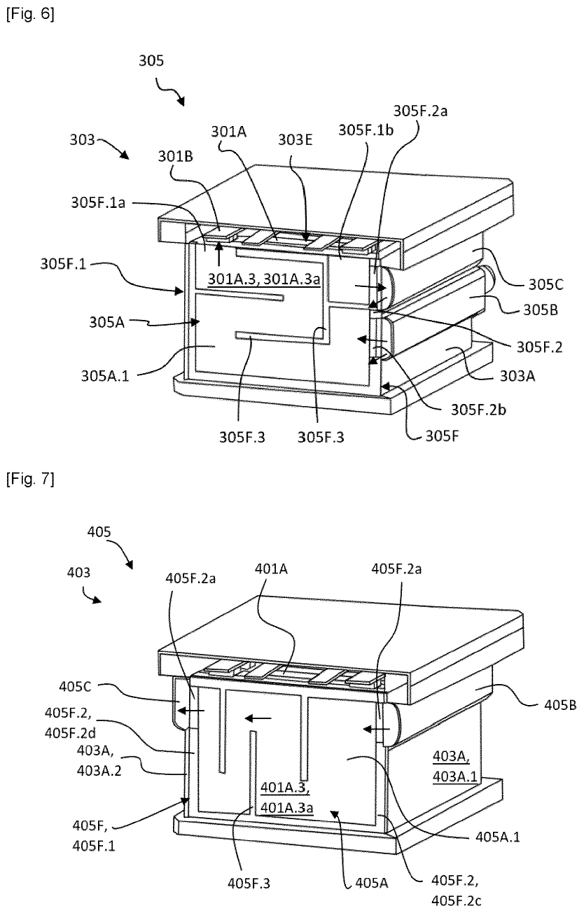

FIG. 6 shows a cross-sectional view of a spacer and the battery pack mounted in the housing according to a fourth embodiment of the invention. This figure repeats the numbering in preceding figures for identical or similar elements, but with the numbering being incremented by 100 relative to the third embodiment of the invention. Reference is also moreover made to the description of these elements that was given with regard to the preceding embodiments of the invention. We will concentrate below on the differences between the preceding embodiments and the fourth embodiment of the invention.

In this fourth embodiment of the invention, the inlet collector 305B and the outlet collector 305C of the heat-transfer fluid extend along the same side wall 303A of the housing 303 of the thermal regulation device 305. The outlet collector 305C is preferably positioned above the inlet collector 305B. At least one or more orifices (305F.2a, 305F.2b, 305F.1a, 305F.1b) are arranged on the spacer 305F, some of these orifices (305F.2b, 305F.2a) opening respectively into the inlet collector 305B and into the outlet collector 305C. More specifically, a lower orifice 305F.2b is arranged in the spacer 305F, and more particularly in one of the small support zones 305F.2 of said spacer 305F, so as to be in fluidic communication with the inlet collector 305B. An upper orifice 305F.2a is also arranged in the spacer 305F, and more particularly in the same small support zone 305F.2 of said spacer 305F, so as to be in fluidic communication with the outlet collector 305C. Two other orifices are also arranged in the upper edge of said spacer 305F, an upper outlet orifice 305F.1a and an upper return orifice 305F.1b, said orifices (305F.1a, 305F.1b) allowing respectively the inlet and outlet of the heat-transfer fluid in the upper space 303E, from and towards said spacer 305F.

Furthermore, the heat-transfer fluid circulates in the collectors (305B, 305C) in the same direction. Thus, if the fluid inlet is positioned on one of the end walls, the outlet is positioned on the other wall of the housing 303 (the end walls not being visible on these figures). The direction of circulation of the heat-transfer fluid is indicated in FIG. 6 by arrows.

Finally, the spacer 305F has vertical and horizontal ribs 305F.3 on the large support zone 305F.1, at one of the large side faces 301A.3 of a cell 301A, more specifically the first large side face 301A.3a of said cell 301A. These ribs 305F.3 will delimit the circulation sections 305A.1 of the heat-transfer fluid at the surface of the cells 301A, so as to allow an effective cooling of said side faces 301A.3. In the same way as before, the spacer 305F is positioned between two adjacent cells 301A and is pressed against said cells 301A so as to allow the sealed circulation of the heat-transfer fluid.

In this embodiment of the invention, the circulation circuit 305A is substantially different from the circulation circuits previously described. In fact, the heat-transfer fluid arrives via the inlet collector 305B, which is preferably positioned on or against the lower end of one of the side walls 303A of the housing 303. The heat-transfer fluid then enters a portion of the circulation circuit 305A via the lower orifice 305F.2b positioned at one of the small support zones 305F.2 of the spacer 305F. Said heat-transfer fluid then circulates in the circulation sections 305A.1 of the portion of said circuit 305A delimited by the spacer 305F, said sections 305A.1 being formed against the large side faces 301A.3 of the adjacent cells 301A, and is then directed towards the upper outlet orifice 305F.1a situated at an opposite end of the spacer 305F of the inlet collector 305B. This orifice 305F.1a is positioned at the upper edge of said support zone 305F.1. Thus, the heat-transfer fluid will be able to flow at the level of the upper space 303E of the housing 303, in particular over and around the busbars 301B. The heat-transfer fluid will then be able to exit the upper space 303E via an upper return orifice 305F.1b situated at the upper edge of the large support zone 305F.1, and at an opposite end to the upper outlet orifice 305F.1a. Said fluid will then be able to rejoin the outlet collector 305C, situated on the upper end of the same side wall 303A as the inlet collector 305B, before being discharged. This embodiment is particularly advantageous if it is desirable to combine a reduction in size of the housing 303 with a cooling of the busbars 301B.

FIG. 7 shows a cross-sectional view of a spacer and the battery pack mounted in the housing according to a fifth embodiment of the invention. This figure repeats the numbering in preceding figures for identical or similar elements, but with the numbering being incremented by 100 relative to the fourth embodiment of the invention. Reference is also moreover made to the description of these elements that was given with regard to the preceding embodiments of the invention. We will concentrate below on the differences between the preceding embodiments and the fifth embodiment of the invention.

In this embodiment, the spacer 405F comprises the large support zone 405F.1, configured to come to bear against the large side face 401A.3 of the cell 401A, more preferably the first large side face 401A.3a of said cell 401A, and the two small support zones 405F.2, configured to come to bear against the small side faces of the cell 401A (the small side faces not being visible in FIG. 7). At least one or more orifices 405F.2a are also arranged on the spacer 405F, each of these orifices 405F.2a opening either into the inlet collector 405B or into the outlet collector 405C.

The housing 403 also comprises the inlet collector 405B and the outlet collector 405C, each collector (405B, 405C) being respectively positioned on one of the two side walls (403A, 403A.1, 403A.2) of said housing 403. The small support zones 405F.2 of the spacer 405F each comprise at least one upper orifice 405F.2a, the orifice 405F.2a of the first small support zone 405F.2c allowing the entry of the heat-transfer fluid into the portion of the circulation circuit 405A of the spacer 405F, and the upper orifice 405F.2a of the second support zone 405F.2d allowing the outlet of said fluid from the portion of the circulation circuit 405A. Also, the spacer 405F has vertical ribs 405F.3 which will delimit the circulation sections 405A.1.

More specifically, the portion of the circulation circuit 405A for the heat-transfer fluid, which is formed in the spacer 405F, has circulation sections 405A.1 of variable width. Advantageously, said sections 405A.1 have a width which decreases from the inlet collector 405B to the outlet collector 405C. Preferably, this decrease many be gradual or continuous. The decreasing width of the circulation sections 405A.1 is between −20% and −80%, and preferably between −40% and −60%. This reduction in width is possible thanks to the spacer 405F, the vertical ribs 405F.3 of which are closer together, the nearer they are positioned to the outlet collector 405C.

Two separate operating modes are then possible.

Firstly, when the pump of the thermal regulation device 405 is in operation (said pump not being visible in this figure), the reduction in size of the circulation sections 405A.1 from the inlet collector 405B to the outlet collector 405C allows an increase in speed of the heat-transfer fluid, while also increasing the turbulence of said fluid. An effective cooling of the large side faces 401A.3 of the cells 401A is then possible.

Then, when the pump of the thermal regulation device 405 is not active (in the case of thermal runaway, for example), the heating of the heat-transfer fluid will nonetheless allow its movement. In fact, the variation in density between the hot fluid and the cold fluid will allow movement of the fluid from bottom to top in the circulation circuit 405A, and the cooling of some of the heat generated by the cell 401A will be maintained. The reduction in width of the circulation sections 405A.1 may then promote the flow of the fluid and improve the cooling of said cell 401A.

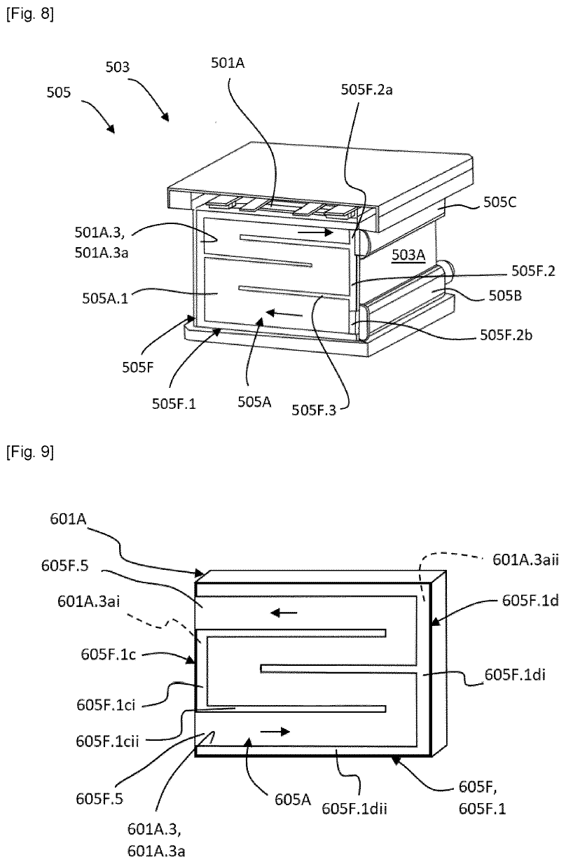

FIG. 8 shows a cross-sectional view of a spacer and the battery pack mounted in the housing according to a sixth embodiment of the invention. This figure repeats the numbering in preceding figures for identical or similar elements, but with the numbering being incremented by 100 relative to the fifth embodiment of the invention. Reference is also moreover made to the description of these elements that was given with regard to the preceding embodiments of the invention. We will concentrate below on the differences between the preceding embodiments and the sixth embodiment of the invention.

In this embodiment, the spacer 505F comprises the large support zone 505F.1 configured to come to rest against the large side face 501A.3 of the cell 501A, more preferably against the first large side face 501A.3a of said cell 501A. The spacer 505F also comprises the two small support zones 505F.2 which are configured to come to bear against the small side faces of the cell 501A (the small side faces not being visible in FIG. 7).

In FIG. 8, the collectors (505B, 505C) are positioned on a single side wall 503A of the housing 503. Also, at least one or more orifices (505F.2b, 505F.2a) are arranged on the spacer 505F, each orifice opening respectively into the inlet collector 505B and into the outlet collector 505C. These orifices (505F.2b, 505F.2a) are positioned on one of the small support zones 505F.2 of the spacer 505F, and comprise at least an upper orifice 505F.2a and a lower orifice 505F.2b, each of said orifices (505F.2a, 505F.2b) being able to allow the passage of the heat-transfer fluid. Preferably, the lower orifice 505F.2b allows the supply of said fluid into the portion of the circulation circuit 505A situated on the spacer 505F, and the upper orifice 505F.2a allows the discharge of said fluid from said portion of the circulation circuit 505A.

This spacer 505F also has the feature of having circulation sections 505A.1 which reduce in width, the closer they are to the outlet collector 505C, as shown in FIG. 7. In this embodiment, this reduction in width is achieved in the height direction and is due to the presence on the spacer 505F of horizontal ribs 505F.3 which extend in the perforated portion of the circulation section 505A.1. The circulation sections 505A.1 are arranged so as to form a portion of the forced-circulation circuit 505A for the heat-transfer fluid between the adjacent cells 501A, the circulation then taking place from bottom to top.

The same features, previously described in FIG. 7, of the circulation sections 505A.1 of the thermal regulation device 505 are also found in FIG. 8 and have the same effects as previously described, the pump being activated or not.

FIG. 9 shows a cross-sectional view of a spacer mounted or not on a battery cell, according to a seventh embodiment of the invention. This figure repeats the numbering in preceding figures for identical or similar elements, but with the numbering being incremented by 100 relative to the sixth embodiment of the invention. Reference is also moreover made to the description of these elements that was given with regard to the preceding embodiments of the invention. We will concentrate below on the differences between the preceding embodiments and the seventh embodiment of the invention.

In this embodiment of the invention, the spacer 605F is designed to be bonded onto one of the large side faces 601A.3 of the cell 601A, preferably the first large side face 601A.3a of said cell 601A.

In order for this spacer 605F to be able to be bonded as effectively as possible, it is preferable that the large support zone 605F.1 is formed from a plurality of segments or independent elements (605F.1c, 605F.1d) which are not connected to one another. In the case where the spacer 605F is constituted by independent elements (605F.1c, 605F.1d), said elements (605F.1c, 605F.1d) are formed by a first element 605F.1c and a second element 605F.1d which are bonded to one of the large side faces 601A.3 of the battery cell 601A.

More specifically, these elements (605F.1c, 605F.1d) have vertical ribs (605F.1ci, 605F.1di) and horizontal ribs (605F.1cii, 605F.1dii) so as to define a portion of the circulation circuit 605A for the heat-transfer fluid within the spacer 605F. Said fluid preferably circulates from bottom to top, between the two large side faces 601A.3 of the two adjacent cells 601A.

Advantageously, the first element 605F.1c has a vertical rib 605F.1ci, which is configured to be positioned against a first side end 601A.3ai of the first large side face 601A.3a of said cell 601A. Two horizontal ribs 605F.1cii extend from the vertical rib 605F.1ci along the first large side face 601A.3a of the cell 601A, the first element 605F.1c being preferably designed to be positioned in the middle of the large side face 601A.3a.

Preferably, the second element 605F.1d has a vertical rib 605F.1di, which is configured to be positioned against a second side end 601A.3aii of the first large side face 601A.3a of the cell 601A. Three horizontal ribs 605F.1dii extend from the vertical rib 605F.1di along the first large side face 601A.3a, the second element 605F.1d being preferably designed to frame, at least partially, the first element 605F.1c. Two of the horizontal ribs 605F.1dii thus frame the first element 605F.1c, the third horizontal rib 605F.1dii extending between the horizontal ribs 605F.1dii of the first element 605F.1c.

Once bonded to one of the large side faces 601A.3 of the cell 601A, these two elements (605F.1c, 605F.1d) will be able to delimit a portion of the circulation circuit 605A which, as before, will allow the passage of the heat-transfer fluid to the surface of the adjacent cells 601A, and hence the cooling of said cells 601A. Because of the bonding of the elements (605F.1c, 605F.1d) directly onto the cell 601A, the spacer 605F naturally has the orifices 605F.5 necessary for movement of the heat-transfer fluid towards and from the portions of the circulation circuit 605A, towards and from the inlet or outlet collectors of the fluid (the collectors not being shown in this figure). At least one or more orifices 605F.5 are arranged on the spacer 605F, each of the orifices 605F.5 being configured to open respectively into the inlet collector and into the outlet collector (the collectors not being visible in these figures).

The spacer 605F may be bonded to the large side face 601A.3 of the cell 601A by any method known to the person skilled in the art.

Thus the spacer 605F according to this embodiment is simpler: it has only one large support zone 605F.1, and is therefore easier and faster to produce. Also, it allows the use of an elastomer to be avoided while retaining a good seal of the spacer 605F, and is therefore less costly to produce.

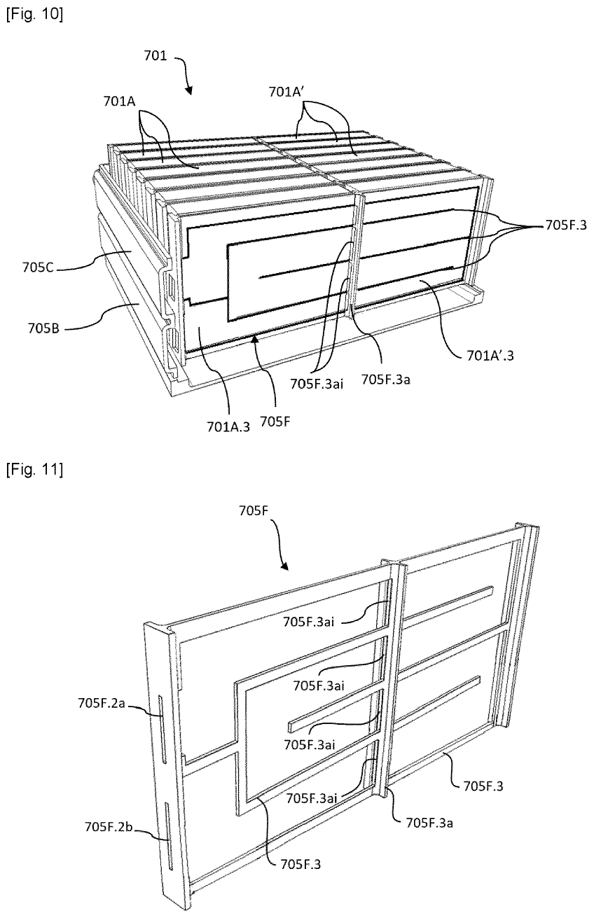

FIGS. 10, 11 and 12 respectively show a cross-sectional view of a thermal regulation device, a perspective view of a spacer, and a cross-sectional view of the device with the collectors positioned on a same side of the housing, according to an eighth embodiment of the invention. These figures repeat the numbering in preceding figures for identical or similar elements, but with the numbering being incremented by 100 relative to the seventh embodiment of the invention. Reference is also moreover made to the description of these elements that was given with regard to the preceding embodiments of the invention.

In this embodiment, the battery pack 701 has two or more positioned rows of cells (701A, 701A′). In FIG. 10, the battery pack 701 is, for example, composed of two rows of cells (701A, 701A′) placed side by side.

To allow the cells (701A, 701A′) to be held in place and to allow a homogeneous flow along their large side faces (701A.3, 701A′.3), the ribs 705F.3 of the spacer 705F are shaped so as to create one or more forced-circulation circuits 705A each having one or more passes, as in the case of a spacer for a single cell described previously.

Advantageously, to ensure that the temperature is as homogeneous as possible, each circuit 705A (and each of its passes) extends over—or straddles—the two large side faces (701A.3, 701A′.3) of the cells (701A, 701A′) arranged side by side.

The spacer 705F forms a fluid-tight seal along the entire length of the circuit 705A, as with a spacer for a single cell described previously.

In FIGS. 10, 11 and 12, the spacer 705F comprises a median rib 705F.3a which extends in the height of the cells (701A, 701A′) and which, in operation, lies between the side edges of the large side faces (701A.3, 701A′.3). This median rib 705F.3a thus fills the space between the two cells (701A, 701A′) and forms a seal between said cells (701A, 701A′). Openings 705F.3ai are provided in the median rib 705F.3a so as to allow the circulation of fluid between the large side faces (701A.3, 701A′.3).

The median rib 705F.3a also allows a spacing of the cells (701A, 701A′) arranged side by side, and plays a mechanical role against the swelling of said cells (701A, 701A′) resulting from their rise in temperature. It contributes further to maintaining the cells (701A, 701A′) in compression under the effect of this swelling, thereby ensuring that said cells (701A, 701A′) can work to their full capacity.

The seal between the cells (701A, 701A′) is particularly advantageous when the fluid inlet/outlet collectors (705B, 705C) are arranged laterally and on a single side of the battery pack 701, as illustrated in FIG. 10. The lower inlet orifice 705F.2b and upper outlet orifice 705F.2a (FIG. 11) of the circuit 705A are then arranged in the spacer 705F, at the level of a rib or a small support zone, situated at the edge of the cell.

If the collectors are positioned on either side of the cells (701A, 701A′) (for example, the inlet collector is positioned on one side of the cell 701A and the outlet collector is positioned on the opposite side of the cell 701A′), this seal will not necessarily be important. In fact, the space between the cells (701A, 701A′) may be used as an intermediate collector, facilitating distribution of the fluid between the cells. In this case, the spacer 705F may not comprise a median rib 705F.3a, or may comprise a median rib 705F.3a which does not fill the space between the two cells (701A, 701A′).

According to another embodiment, the ribs 705F.3 may be arranged so as to form a first circuit which snakes along the large side face 701A.3 of the first cell 701A, and a second circuit which snakes along the large side face 701A′.3 of the second cell 701A′. The communication between the two circuits may take place at the top wall 703C (more particularly, at the busbar zone) or at the bottom wall 703D of the housing 703. This embodiment has the advantage of not requiring a seal between the cells (701A, 701A′), but is not optimal in terms of homogeneity of temperature because the fluid reaching the second cell 701A′ is hotter than when reaching the first cell 701A.

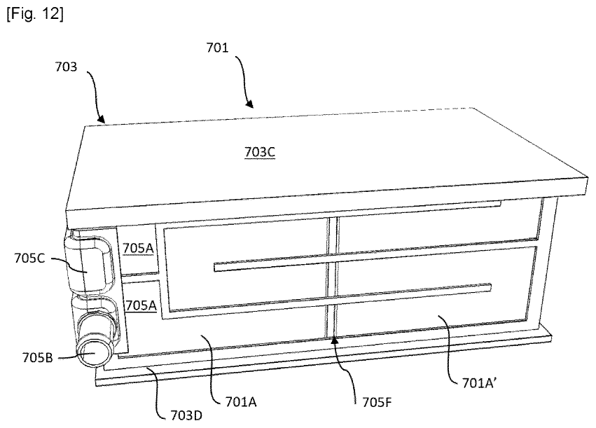

In FIG. 12, the fluid inlet/outlet collectors (705B, 705C) are arranged laterally and on a single side of the battery pack 701. To ensure the supply to one or more cells 701A situated at the ends of the battery pack 701, the inlet collector 705B and/or the outlet collector 705C may be extended and elbowed so as to open directly into the circuit 705A formed at the level of at least one of said end cells.

According to one embodiment of the invention not shown in the figures, a motor vehicle generally comprises a cooling system. This system comprises a battery pack, a thermal regulation device according to the invention, and at least one spacer. The thermal regulation device for this vehicle may comprise one or more of the features mentioned above in the various embodiments of the invention.

The arrangement of the various elements and/or means and/or steps of the invention, in the embodiments described hereinabove, must not be interpreted as demanding such an arrangement in all implementations. In any case, it will be appreciated that various modifications may be made to these elements and/or means and/or steps without departing from the spirit and scope of the invention.

Furthermore, one or more of the features set out in just one embodiment may be combined with one or more other features set out in just one other embodiment. Likewise, one or more features set out in just one embodiment may be generalized to the other embodiments, even if this or these features are described only in combination with other features.

The use of the verbs “have”, “comprise” or “include” and conjugated forms thereof does not exclude the presence of elements or steps other than those stated in a claim.

1. A thermal regulation device for a vehicle battery pack, said thermal regulation device comprising:
a housing forming an enclosure sealed against a heat-transfer fluid, having at least two side walls and a top wall, and comprising:
a circulation circuit for the heat-transfer fluid,
wherein the housing is configured to house the battery pack,
wherein the battery pack comprises at least two battery cells,
wherein the heat-transfer fluid circulating around the battery cells for thermal regulation thereof;
inlet and outlet collectors respectively for supply and discharge of the heat-transfer fluid to/from said circulation circuit; and
a spacer configured to be installed between the battery cells so as to space them apart from one another,
wherein at least one of the collectors extends along at least one side wall of the housing,
wherein the circulation circuit for the heat-transfer fluid is defined at least in part by the spacer,
wherein at least two orifices are arranged on the spacer,
wherein each of the orifices opening respectively into the inlet collector and/or into the outlet collector.

2. The thermal regulation device as claimed in claim 1, wherein the inlet and outlet collectors extend respectively along each of the two side walls.

3. The thermal regulation device as claimed in claim 1,
wherein the battery pack also comprises busbars situated in an upper space formed between the battery cells and the top wall of the housing,
wherein one of said collectors of the device, advantageously the inlet collector, extends along one of the side walls while the other collector is formed, at least in part, by the upper space.

4. The thermal regulation device as claimed in claim 1, wherein a fluidic connection between a collector and the spacer is achieved by addition of a piece or by extension of the spacer allowing the spacer to be held on the battery cell.

5. The thermal regulation device as claimed in claim 1, wherein the circulation circuit for the heat-transfer fluid comprises fluid circulation sections of variable width, these circulation sections of variable width being formed by the spacer.

6. The thermal regulation device as claimed in claim 1, wherein the circulation circuit for the heat-transfer fluid comprises fluid circulation sections of width which decreases from the inlet collector towards the outlet collector.

7. The thermal regulation device as claimed in claim 6, wherein the decreasing width of the fluid circulation sections from the inlet collector towards the outlet collector is between −20% and −80%.

8. The thermal regulation device as claimed in claim 1, wherein the spacer is clipped onto at least one battery cell or bonded to at least one battery cell.

9. The thermal regulation device as claimed in claim 8, wherein, when the spacer is bonded, the spacer is formed from a plurality of segments or independent elements.

10. A cooling system comprising:
the thermal regulation device as claimed in claim 1; and
a battery pack comprising N adjacent battery cells, including two end battery cells each arranged at one end wall of the housing, N being a whole number greater than 3,
wherein the thermal regulation device comprising at least N−1spacers.

11. The cooling system as claimed in claim 10,
wherein the spacer is installed between each battery cell that is adjacent to another battery cell,
wherein the spacer is installed between each end wall of the housing and the end battery cell, a large side face of which is adjacent to said wall,
wherein the spacers are in contact with the adjacent large side faces of said battery cells, such that all the large side faces of the battery cells are cooled by the circulation circuit for the heat-transfer fluid.

12. The cooling system as claimed in claim 11,
wherein the N adjacent battery cells of the battery pack form two or more rows of battery cells placed side by side,
wherein each spacer comprises ribs shaped so as to create one or more forced-circulation circuits, each said circuit having one or more passes straddling the two large side faces of two battery cells arranged side by side,
wherein each spacer comprises a median rib which extends in a height of said battery cells and which, during use, lies between lateral edges of said large side faces, such that said median rib fills the space between the two battery cells and forms a seal between said battery cells.

13. The cooling system as claimed in claim 12, wherein: openings are provided in the median rib so as to allow the circulation of fluid between the large side faces of two battery cells arranged side by side.

14. The cooling system as claimed in claim 12, wherein an inlet collector and/or an outlet collector are extended and elbowed so as to open directly into the forced-circulation circuit formed at a level of at least one of the end battery cells.
